(19) United States
(12) Patent Application Publication
(10) Pub. No.: US 2026/0214114 A1
(43) Pub. Date: Jul. 23, 2026

(54) PREDICTING ATTACK PATHS

(71) Applicant: BRITISH TELECOMMUNICATIONS PUBLIC LIMITED COMPANY, London (GB)

(72) Inventors: Fadi EL-MOUSSA, London (GB); Ian HERWONO, London (GB)

(21) Appl. No.: 19/137,929

(22) PCT Filed: Dec. 8, 2023
(86) PCT No.: PCT/EP2023/084972

§ 371 Date: Jun. 11, 2025

(30) Foreign Application Priority Data
Dec. 22, 2022 (EP) 22215970.9
Dec. 22, 2022 (GB) 2219545.7

(51) Int. Cl. H04L 9/40; H04L 41/16

(52) U.S. Cl. CPC H04L 63/1433; H04L 41/16

(57) ABSTRACT

A computer-implemented method for predicting attack paths in a computer system or network is disclosed The method comprises: obtaining historical attack data, creating an attack graph based on the historical attack data, monitoring the computer system or network for attacks or attempted attacks and correlating those attacks or attempted attacks with one or more of the plurality of nodes of the attack graph, interrogating the computer system or network to determine one or more attributes, training a machine learning model to predict the most likely attack path, outputting a prediction of the most likely attack path for the computer system or network such that mitigation action can be taken to prevent or reduce cyberattacks in the computer system or network in dependence on the prediction of the most likely attack path.

### TECHNICAL FIELD

Embodiments of the present invention described herein relate to methods and systems for predicting attack paths in a computer system or network.

### BACKGROUND

Attack paths describe the sequence of steps or activities that an adversary could take to prepare and launch a cyber-attack. An adversary may employ specific technique in each step/activity to achieve their interim goal which then allows them to move on to the next step, getting closer to their final goal. Knowing the attack paths that an adversary may follow to infiltrate a network would be very useful for an automated cyber-defence system to detect and stop the attack as early as possible and mitigate the impact. Each attack path represents a possible cyber kill chain for gaining privileged access to the network and launching high-impact attacks such as ransomware or data exfiltration attacks. A cyber kill chain outlines the various stages of several common cyberattacks and, by extension, the points at which a security team can prevent, detect or intercept attackers. FIG. 2 shows an example attack path comprising four attack steps/techniques with the final objective of data exfiltration.

The attack steps or techniques that need to be detected by a cyber-defence system are specified in the following (chronological) order:
1. Drive-by Compromise 202: The adversary is trying to gain access to a system by misleading user to a malicious website over the normal course of browsing.
2. Signed Script Proxy Execution 204: The adversary is trying to avoid being detected by using scripts signed with trusted certificates to proxy execution of malicious files.
3. Registry Run Keys/Startup Folder 206: The adversary is trying to maintain their foothold by adding a program to a startup folder or referencing it with a Registry run key.
4. Data Exfiltration 208: The adversary is trying to steal or exfiltrate data such as sensitive documents using automated processing method.

### SUMMARY OF THE DISCLOSURE

The present disclosure addresses the problem of how to improve predictivity of most likely attack paths for computer systems/networks, by providing methods and systems which can predict the entirety of an attack path for a given computer system/network based on an historical attack data for that computer system/network, and attributes relating to different parts of the system/network determined through interrogation of the system/network. This prediction can then be used to inform mitigation action to improve the security of the system.

In view of the above, from a first aspect, the present disclosure relates to a computer-implemented method for predicting attack paths in a computer system or network. The method comprises: obtaining historical attack data relating to the computer system or network, the historical attack data comprising data relating to previous attacks or previous attempted attacks on the computer system or network; creating an attack graph based on the historical attack data, the attack graph comprising: (i) a plurality of nodes relating to a plurality of attack techniques, and (ii) a plurality of possible attack paths; monitoring the computer system or network for attacks or attempted attacks and correlating those attacks or attempted attacks with one or more of the plurality of nodes; interrogating the computer system or network to determine one or more attributes relating to each of the one or more of the plurality of nodes; training a machine learning model to predict the most likely attack path of the plurality of possible attack paths based on: (i) the one or more attributes; and (ii) the historical attack data and/or data relating to the monitored attacks or attempted attacks; using the trained machine learning model to output a prediction of the most likely attack path for the computer system or network such that mitigation action can be taken to prevent or reduce cyberattacks in the computer system or network in dependence on the prediction of the most likely attack path.

Several advantages are obtained from embodiments according to the above-described aspect. For example, the above-described aspect allows a tailored approach to be taken for each computer system or network. Every computer system/network or even user profile is different, and thus predicting cyberattacks based on individual systems/networks/user profiles is advantageous over predicting cyberattacks on a whole IT environment basis. Each individual system/network may have specific characteristics, e.g., different operating systems, firewall settings, installed software, network connectivity, etc., that make it less or more vulnerable or susceptible to certain type of attack. Another advantage is that this method takes into account why some attack paths are more likely than others by dynamically interrogating the system to determine one or more attributes—the prediction is based on more than just statistics from historical attack data. Another advantage is that the above-described aspect predicts a whole attack path, rather than just the next step of an attack path, given a current step. This is advantageous as it allows cybersecurity teams to see in advance what the most likely attack path is through the system, and thus take mitigation action to prevent the attack before it has even started.

In some embodiments, the method further comprises outputting a suggestion of mitigation action to prevent or reduce cyberattacks in the computer system or network in dependence on the prediction of the most likely attack path, the suggestion being outputted to a user.

This is advantageous because, as explained above, the machine learning (ML) model takes into account why some attack paths are more likely than others, and thus, based on this information, the model can output a suggestion of how to improve the security of the system/network.

In some embodiments, the method further comprises taking mitigation action to prevent or reduce cyberattacks in the computer system or network in dependence on the prediction of the most likely attack path.

This is advantageous as this improves the security of the system/network, closing loopholes in security and preventing future cyberattacks.

In some embodiments, the mitigation action comprises minimising one or more weaknesses in the computer system or network, the one or more weaknesses being identified in the one or more attributes.

This is advantageous as, for example, the ML model may identify that the most likely attack path to be used uses the process injection technique. By interrogating the system, the method may suggest that the reason why the process injection technique is attractive to attackers is because there are security kernel modules missing from the system (a weakness). The mitigation action to be taken, based on the most likely attack path, would therefore be to deploy those security kernel modules, thereby closing that hole in the security of the system/network.

In some embodiments, the method further comprises repeating the method of the first aspect after mitigation action has been taken to output an updated prediction of the most likely attack path.

This is advantageous because, as a consequence of the mitigation action taken, the identified most likely attack path will ideally no longer be the most likely attack path. The ML model can then be re-trained with the latest data, thus re-interrogating the system/network to update the one or more attributes to reflect the mitigation action taken. There will therefore be a new most likely attack path.

In some embodiments, the method further comprises outputting an updated suggestion of mitigation action in dependence on the updated prediction, the updated suggestion being outputted to a user.

This is advantageous as the mitigation process can be repeated to fix weaknesses making the updated most likely attack path most attractive. This can repeat until the computer system/network reaches a desired threshold of security.

In some embodiments, the machine learning model is dynamically updated when new historical attack data becomes available.

This is advantageous because the accuracy of the model increases as the amount of historical data increases. By dynamically updating the ML model when new historical attack data becomes available, the model improves over time.

In some embodiments, the dynamic updating comprises repeating the method of claim 1 with the new historical attack data.

In some embodiments, the interrogating step is performed upon detection of an attack or an attempted attack during the monitoring of the computer system or network.

This is advantageous because the technique used in the attack or attempted attack can be identified and then the system can be interrogated to find which attributes are relevant to that technique, thus finding information on why that technique was used by the attacker. This data is then used to train the ML model.

In some embodiments, the method further comprises obtaining an attack path blueprint of the computer system or network, and wherein the creating of the attack graph uses the historical attack data and the attack path blueprint.

This is advantageous because the attack graph can be created automatically based on the observations of historical attack events or logs (historical attack data) in combination with a template or “blueprint” of possible attack paths (referred to as “attack path blueprint”) that maps or groups the attack techniques to relevant attack tactics (for example, the MITRE ATT&CK framework). The use of such an attack path blueprint is useful to make detection of each attack step more flexible.

In some embodiments, the method is for predicting attack paths for a specific user profile in a computer system or network, such that the computer system or network is a specific user profile of the computer system or network, such that the most likely attack path is predicted for the specific user profile.

This is advantageous because, as described above, a tailored approach to be taken for each computer system or network, and in particular, each user profile of the computer system/network. Every user profile is different, and thus predicting cyberattacks based on individual user profiles is advantageous. For example, each user may have specific access to server or applications and also has different environment settings on their machine, e.g., a software developer may have different system settings on their laptop compared to the ones of a sales unit employee.

In some embodiments, the machine learning model predicts the most likely attack path of the plurality of attack paths by: (a) for each of the plurality of possible attack paths, determining a probability of an attacker using that attack path based on (i) the one or more attributes; and (ii) the historical attack data; and (b) selecting the attack path with the highest probability as the most likely attack path.

In some embodiments, the machine learning model predicts the most likely attack path of the plurality of possible attack paths by: (a) dividing the attack graph into a plurality of subgraphs, each subgraph comprising a subset of the plurality of nodes and a plurality of subgraph paths, wherein each subgraph path is part of at least one of the plurality of possible attack paths, and each subgraph path connects a first node to a second node; (b) for each subgraph path, determining a probability of an attacker taking that subgraph path based on (i) the one or more attributes relating to the second node; and (ii) the historical attack data; (c) for each of the plurality of possible attack paths, determining a probability of an attacker using that attack path by: determining which subgraph paths combine to form the attack path; and combining the probabilities associated with the determined subgraph paths together; and (d) selecting the attack path with the highest probability as the most likely attack path.

This is advantageous as this allows the ML model to chain attributes together to predict the full attack path, rather than just predicting the next step based on the current position of an attacker.

In some embodiments, for each subgraph path, determining a probability of an attacker taking that subgraph path is additionally based on the one or more attributes relating to the first node.

This is advantageous because the possibility/likelihood of the next attack technique may also depend on the attributes that had enabled the first node in the first place, e.g., the use of attack technique B is made easier because the adversary managed to successfully use attack technique A on the system/network.

From a second aspect, the present disclosure relates to a system comprising: a processor; and a memory including computer program code; the memory and the computer code configured to, with the processor, cause the system to perform the method of any of the above-described embodiments of the first aspect.

### BRIEF DESCRIPTION OF THE DRAWINGS

Embodiments of the present invention will now be further described by way of example only and with reference to the accompanying drawings, wherein:

FIG. 1 is a block diagram of a system according to an embodiment of the present invention.

FIG. 2 illustrates an attack path or cyber kill chain for data exfiltration.

FIG. 3 illustrates an example attack path blueprint using the MITRE ATT&CK framework.

FIG. 4 illustrates observed kill chains and attack paths with different frequencies of occurrence (the thicker the line, the more frequent the occurrence).

FIG. 5 illustrates a collection of common and technique-specific sets of attributes for each attack technique in the kill chain.

FIG. 6 illustrates a technical approach for attack path prediction based on IT assets and user information, in accordance with embodiments of the present invention.

FIG. 7 illustrates an example for a complete attack graph model, in accordance with embodiments of the present invention.

FIG. 8 illustrates segmentation of a complete attack graph, in accordance with embodiments of the present invention.

FIG. 9 illustrates a machine learning classifier model for each sub attack graph, in accordance with embodiments of the present invention.

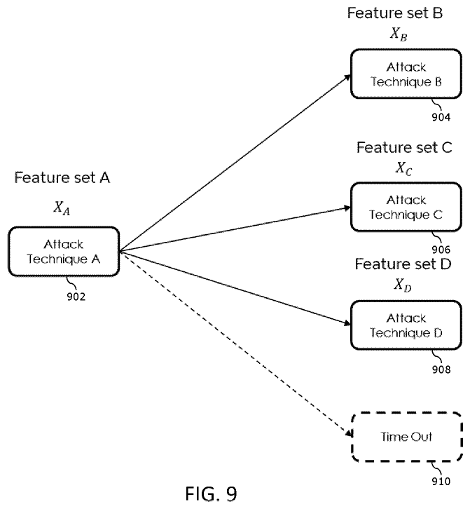

FIG. 10 illustrates use of the trained machine learning model to predict the outcome, i.e., probability of the next attack technique or timeout, in accordance with embodiments of the present invention.

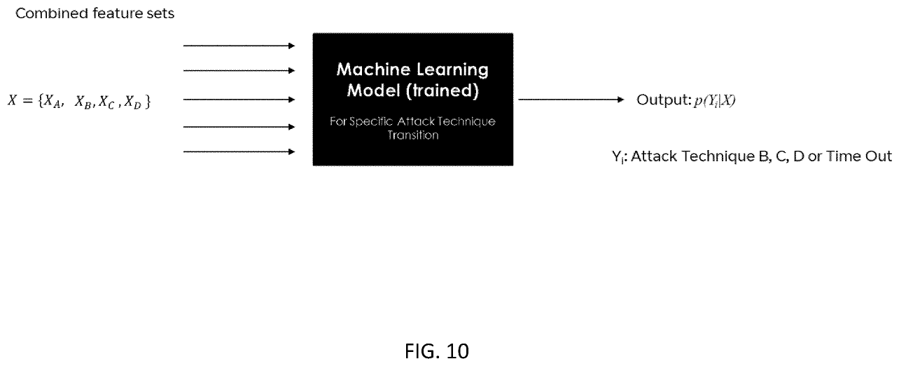

FIG. 11 illustrates determination of an attack path probability based on two sub attack graph's machine learning models, in accordance with embodiments of the present invention.

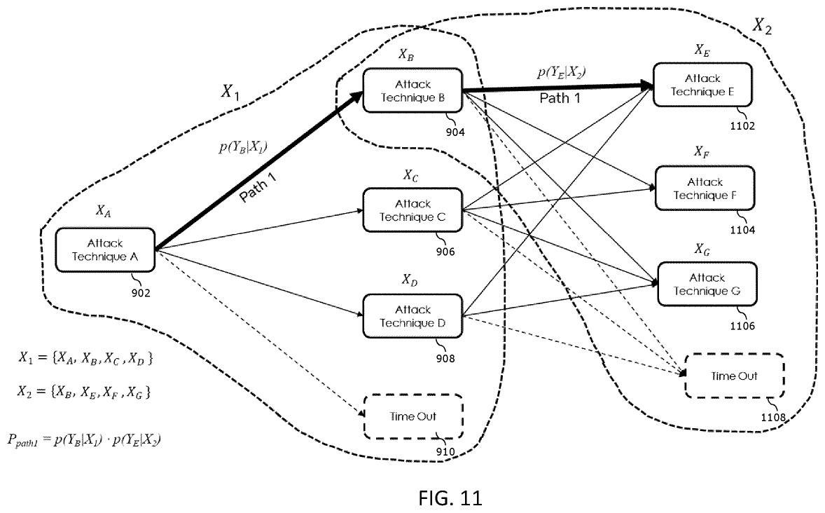

FIG. 12 illustrates prediction of the most likely attack path by comparing the probabilities of all potential attack paths, in accordance with embodiments of the present invention.

### DESCRIPTION OF THE EMBODIMENTS

### Overview

Embodiments of the present invention provide a computer-implemented method for predicting attack paths in a particular computer system or network. The prediction can then be used to inform mitigation action to be taken to prevent or reduce cyberattacks in the particular computer system or network.

Attack paths are defined at a granular level comprising a graph of individual techniques utilised by an adversary to achieve their attack. Techniques are attributed to tactics (generalisations of techniques) and techniques within a tactic are conceivably interchangeable. A complete attack graph comprises multiple attack paths representing the cyber kill chains. Attack graphs can be utilised by a cyber-defence system to systematically observe and correlate the relevant security events in accordance with the sequence/order of the attack steps.

Embodiments of the present invention present a method to calculate and determine the probability or likelihood that an adversary (an attacker) may go through or follow a specific attack path based on dynamic interrogation of the (victim) system or network. By collecting specific information or profile from a system or its users, it should become clearer whether the adversary may or may not succeed to compromise the system using a specific attack technique. This insight will be used to predict the attack path that may likely be followed by an adversary to achieve their objective; any measures (mitigation action) that are necessary to prevent the attack going forward can then be taken as soon as possible, e.g., isolating specific applications or network services.

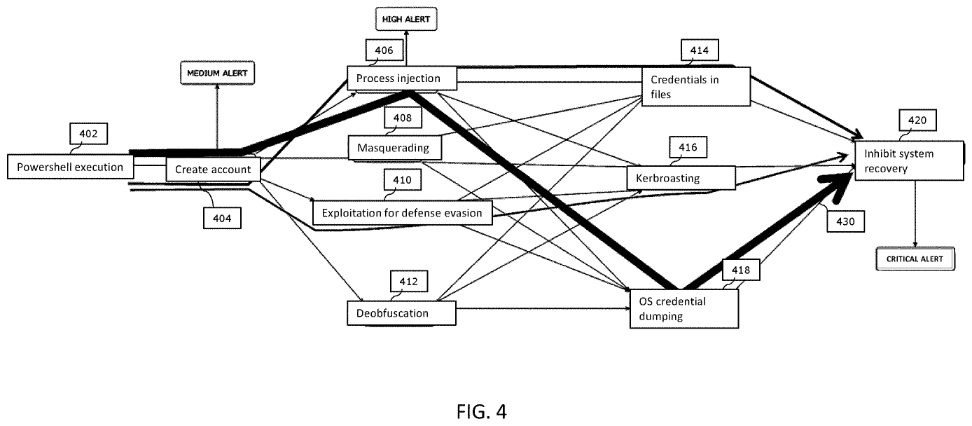

Embodiments of the present invention can be summarised as follows:
1. Use the attack graph to monitor the security events or alerts. The attack graph may be created manually by an expert using historical attack data, or automatically using an attack path blueprint (e.g., the MITRE ATT&CKⁱ framework) combined with historical attack data. This historical attack data comprises data on previous attacks or previous attempted attacks on the specific system/network of interest. The historical attack data therefore provides statistics on which attack paths within the attack graph blueprint are most often used. This helps to simplify the attack path blueprint (which may be complex) to those attack paths which are used by attackers. ⁱ https://attack.mitre.org
2. Collect information or profile about the computer system/network and users impacted by specific attack technique. For example, if the attack graph/historical attack data suggests that “masquerading” is a technique often used by attackers, the system/network is interrogated for attributes (likely to be weaknesses in the system/network) which make masquerading an attractive technique to use—e.g., the interrogation may find that the system/network has weak authentication processes. Conversely, if the attack graph/historical attack data suggests that “process injection” is a technique rarely used by attackers, the system/network is interrogated for attributes (likely to be strengths in the system/network) which make process injection an unattractive technique to use—e.g., the interrogation may find that the system/network has security kernel modules that provide advanced access control and process restrictions. The different techniques, e.g., masquerading and process injection are located at different nodes of the attack graph. Thus, embodiments of the present invention interrogate the computer system/network to determine one or more attributes relating to each of the plurality of nodes of the attack graph. This builds up a picture of why attackers are choosing certain attack paths and not others.
3. Build and train a machine learning (ML) classifier model based on the collected information/profiles (i.e., the one or more attributes and the historical attack data).
4. Use the ML classifier to predict possible attack paths for a given computer system/network. Once trained, the ML model is able to predict which attack path out of all of the possible attack paths in the attack graph is most likely (most probable) to be used by an attacker looking to compromise the system/network.
5. The output of the most likely attack path can then be used to advise mitigation action in order to improve the security of the system/network (i.e., to prevent or reduce cyberattacks in the computer system or network).
   For example, if the most likely attack path is determined to be: Powershell execution→create account→process injection→OS credential dumping→Inhibit system recovery (see FIG. 4), and one of the reasons why is because there are specific security kernel modules missing which make process injection an attractive technique, one of the ways to take mitigation action to prevent attackers taking this path would be to deploy the specific security kernel modules. Then, this attack path is no longer an attractive option as this mitigation action deters attackers from using the process injection technique.
   Once the most likely attack path has been “fixed” by taking mitigation action, the ML model can be re-run (and may automatically do so) to determine the new most likely attack path. The mitigation process can then be repeated to take further mitigation action to “fix” the new most likely attack path, and so on.

Various aspects and details of these principal components will be described below with reference to the Figures.

### The Computer System

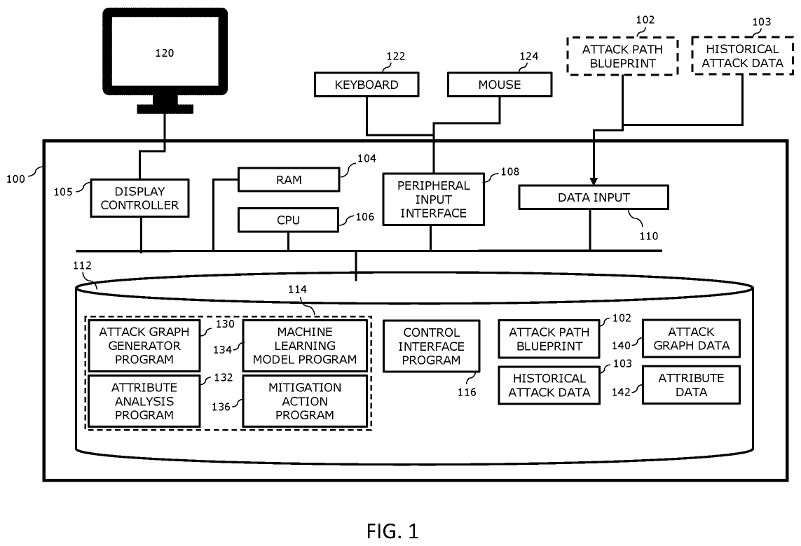

An example of a computer system used to perform embodiments of the present invention is shown in FIG. 1.

FIG. 1 is a block diagram illustrating an arrangement of a system according to an embodiment of the present invention. Some embodiments of the present invention are designed to run on general purpose desktop or laptop computers. Therefore, according to an embodiment, a computing apparatus 100 is provided having a central processing unit (CPU) 106, and random access memory (RAM) 104 into which data, program instructions, and the like can be stored and accessed by the CPU. The apparatus 100 is provided with a display screen 120, and input peripherals in the form of a keyboard 122, and mouse 124. Keyboard 122, and mouse 124 communicate with the apparatus 100 via a peripheral input interface 108. Similarly, a display controller 105 is provided to control display 120, so as to cause it to display images under the control of CPU 106. Attack path blueprint 102 (optional) and historical attack data 103 can be input into the apparatus and stored via data input 110. In this respect, apparatus 100 comprises a computer readable storage medium 112, such as a hard disk drive, writable CD or DVD drive, zip drive, solid state drive, USB drive or the like, upon which attack path blueprint 102 and historical attack data 103 can be stored. Alternatively, the data 102, 103 could be stored on a web-based platform, e.g. a database, and accessed via an appropriate network. Computer readable storage medium 112 also stores various programs, which when executed by the CPU 106 cause the apparatus 100 to operate in accordance with some embodiments of the present invention.

In particular, a control interface program 116 is provided, which when executed by the CPU 106 provides overall control of the computing apparatus, and in particular provides a graphical interface on the display 120 and accepts user inputs using the keyboard 122 and mouse 124 by the peripheral interface 108. The control interface program 116 also calls, when necessary, other programs to perform specific processing actions when required. For example, an attack graph generator program 130 may be provided which is able to operate on attack path blueprint 102 and historical attack data 103 indicated by the control interface program 116, so as to output attack graph data 140 containing a plurality of possible attack paths. An attribute analysis program 132 may be provided which is able to operate on attack graph data 140 indicated by the control interface program 116, so as to output attribute data 142. A machine learning model program 134 may be provided which is able to operate on attribute data 142 and historical attack data 103 indicated by the control interface program 116, so as to output the most likely attack path out of the plurality of possible attack paths contained in the attack graph data 140. Optionally, there may be provided a mitigation action program 136 which is able to recommend or perform mitigation action to prevent or reduce cyberattacks, in dependence on the predicted most likely attack path.

The operations of the attack graph generator program 130, attribute analysis program 132, machine learning model program 134 and mitigation action program 136 are described in more detail below.

The detailed operation of the computing apparatus 100 will now be described. Firstly, the user launches the control interface program 116. The control interface program 116 is loaded into RAM 104 and is executed by the CPU 106. The system user then launches a program 114, which may be comprised of the attack graph generator program 130, attribute analysis program 132, machine learning model program 134 and mitigation action program 136. The programs act (directly or indirectly) on the input data 102, 103 as described below.

### Predicting the Most Likely Attack Path

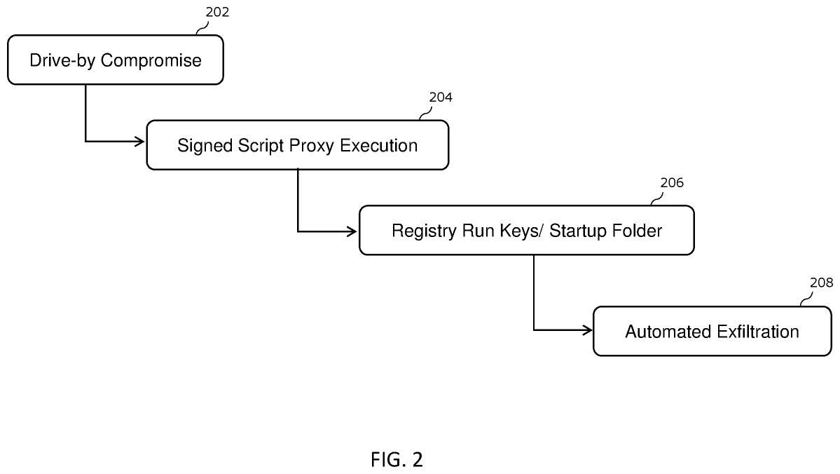

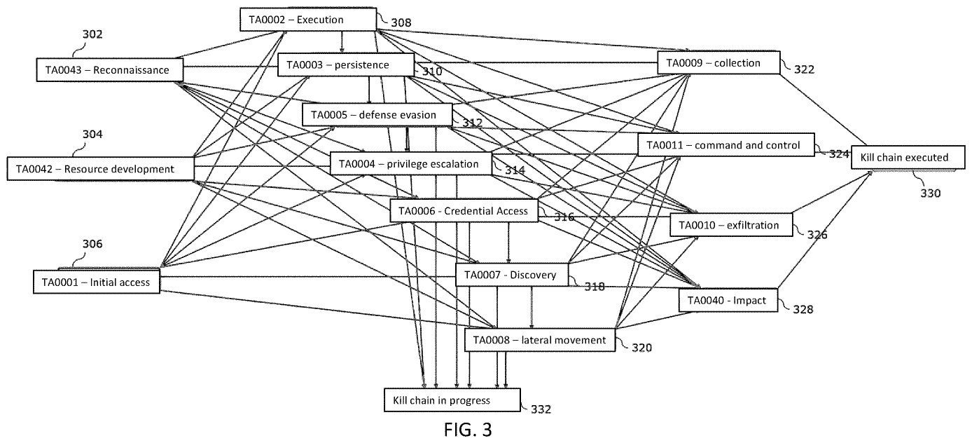

FIG. 2 illustrates an example attack path. The attack path is linear and is as follows: “Drive-by Compromise” 202, “Signed Script Proxy Execution” 204, “Registry Run Keys/Startup Folder” 206 and “Automated Exfiltration” 208. An attack path, like the one shown in Error! Reference source not found.2, can manually be specified/defined by a cyber-defence expert based on known TTP (Tactics, Techniques and Procedures) combined with the expert's experience and intimate knowledge of the network in question. It is also possible to create such attack path automatically based on the observations of historical attack events or logs (referred to as historical attack data 103) in combination with a template or “blueprint” of possible attack paths (referred to as “attack path blueprint 102”) that maps or groups the attack techniques to relevant attack tactics (MITRE ATT&CK framework). The use of such an attack path blueprint is useful to make detection of each attack step more flexible; for example, the attack technique “Drive-by Compromise” 202 is grouped into attack tactic “Initial Access” 302 (see FIG. 3) which also covers other techniques such as “Phishing” or “External Remote Services”. Hence if the adversary chose to use the “Phishing” technique to start their attack it will also be detected by the cyber-defence system as the first step of the attack path or kill chain.

FIG. 3 shows an example of such an attack path blueprint based on the MITRE ATT&CK framework. It comprises 14 tactics (“Reconnaissance” 302, “Resource Development” 304, “Initial Access” 306, “Execution” 308, “Persistence” 310, “Defense Evasion” 312, “Privilege Escalation” 314, “Credential Access” 316, “Discovery” 318, “Lateral Movement” 320, “Collection” 322, “Command and Control” 324, “Exfiltration” 326 and “Impact” 328) that are interconnected as graph nodes in such a way to build a structure of potential kill chains (possible attack paths). Tactics 308-320 are connected to the node “Kill Chain in Progress” 332. Tactics 322-328 are connected to the node “Kill Chain Executed”, as after these tactics are successfully performed, the kill chain is complete and the system is compromised. A number of attack techniques are associated to each of the tactics 302-328. By monitoring the security events continuously (to obtain historical attack data 103) and matching them against such attack path blueprint 102, various attack paths can then be observed and identified from the data to form an attack graph 140—it is likely that some attack paths will have been observed more frequently than the others, thus indicating those attack paths are more likely to be taken by an attacker. The process of forming these attack graphs 140 may be performed by the attack graph generator program 130 which takes the historical attack data 103 and optionally the attack path blueprint 102 and identifies the plurality of possible attack paths which make up the attack graph data 140.

Error! Reference source not found.4 shows an example attack graph 140 comprising multiple attack paths that have been observed from historical attack data 103 and derived from the attack path blueprint 102. Each attack path comprises a sequence of attack techniques:
Powershell execution technique 402 is associated to Execution tactic 308
Create account technique 404 is associated to Persistence tactic 310
Process injection 406, Masquerading 408, Exploitation for defense evasion 410, and Deobfuscation techniques 412 are associated to Defense Evasion tactic 312
Credentials in files 414, Kerberoasting 416, and OS credential dumping 418 techniques are associated to Credential Access tactic 316
Inhibit system recovery technique 420 is associated to Impact tactic 328

The three lines indicate three possible attack paths with different frequencies of occurrence. The attack path with the thick line 430 is the most prevalent attack path observed from the data; the sequence of the involved attack techniques is:
1. Powershell execution 402: Adversaries may abuse Windows Powershell commands and scripts for downloading and running executables/malware on victim systems.
2. Create account 404: Adversaries may create a local user account to maintain access to victim systems.
3. Process injection 406: Adversaries may inject code into processes in order to evade process-based defences as well as possibly elevate privileges.
4. OS credential dumping 418: Adversaries may attempt to dump credentials to obtain account login and credential material, normally in the form of a hash or a clear text password, from the operating system and software.
5. Inhibit system recovery 420: Adversaries may delete or remove built-in operating system data and turn off services designed to aid in the recovery of a corrupted system to prevent recovery.

Having the knowledge of such a dominant attack path is very useful for the cyber-defence team in order to optimise their response and prepare effective mitigation measures and/or to improve the security of the affected systems. However, the following questions remain unanswered, e.g.,
Why did the adversary follow specific attack paths to achieve their objective?
Why has one attack path been observed much more frequently than the others?
Why did the adversary not choose some attack paths at all?

Based on observing the security events alone, it remains very difficult to understand the “Why” or the main reasons behind the observed paths; is it because the system has not been patched, firewall policy outdated or new hardware/software has been added, etc.?

Knowing the cause of why specific attack paths were being followed by adversaries or seem to be more prevalent than the others is key to improve the cyber-defence system as well as the overall security of the enterprise networks and IT assets (referred to herein as computer systems/networks). Furthermore, based on that knowledge the ability to predict the attack technique that an adversary may use next to achieve their final objective is very important to increase the efficiency of the security controls and allocation of (human) resources (i.e., front-end security analysts).

To address these issues, embodiments of the present invention present a method to calculate and determine the probability or likelihood that an adversary may go through or follow a specific attack path based on dynamic interrogation of the (victim) system or network. By collecting specific information or profile from a system or its users (i.e., collecting one or more attributes), it should become clearer whether the adversary may or may not succeed to compromise the system using a specific attack technique (e.g., process injection, masquerading, etc.). This insight will then be used to predict the most likely attack path to be followed by an adversary to achieve their objective. Any measures (mitigation action) that are necessary to prevent the attack going forward can then be taken as soon as possible, e.g., isolating specific applications or network services.

Embodiments of the present invention aim to fill the gaps that an existing cyber-defence system has. The kill chains, such as the ones shown in FIG. 4, would normally have been identified by a current cyber system based on observations of historical security events covering all systems or machines and users within an enterprise IT environment, rather than a specific tailored approach to each individual system/network. Any prediction made regarding the next likely attack event in the kill chain would be based only on the statistical properties of the observed events in the whole IT environment. However, each individual system/network may have specific characteristics, e.g., different operating systems, firewall settings, installed software, network connectivity, etc., that make it less or more vulnerable or susceptible to certain type of attack. Therefore, in reality, the most likely next step of an attack is likely to be different for each system/network. Thus, the approach of treating IT environments as a whole is not adequate and leads to sub-optimum cyber security measures. Furthermore, each user may have specific access to server or applications and also has different environment settings on their machine, e.g., a software developer may have different system settings on their laptop compared to the ones of a sales unit employee. Over time or temporarily the configuration of each machine or software may also change which affects its vulnerability status to certain attack. For example, specific firewall settings may be changed temporarily to allow for installing and testing new software applications or service, or a newly installed software may still have default administrative settings (e.g., the admin's password is still set to “admin”). Thus, the most likely step of an attack may differ between each user's system. This is not accounted for in approaches which treat IT environments as a whole, rather than on a system by system basis. Finally, each attack technique will have certain pre-requisites to succeed, e.g., using the Kerberoasting attack technique would only be possible if the victim machine has access or connectivity to a Kerberos ticketing system. Thus it is advantageous to provide a method which takes all of the information about the systems and users into account when making predictions about potential attack paths.

With more information available about the victim system, via interrogating the system to determine one or more attributes relating to each node (technique) in the attack graph, the example of the most prevalent attack path identified in FIG. 4 could have been predicted as follows:
The difference between the attack paths starts from the third step, i.e., Process injection 406, Masquerading 408, Exploitation for defense evasion 410, or Deobfuscation 412.
Adversaries may be more likely to proceed with the Process injection 406 or Masquerading 408 techniques because, for example, the interrogation of the system found out the following:
   There are several applications running on the system that are not well protected and not running in a sandbox environment or Virtual Machine, that makes the system more susceptible to Process injection 406 attack.
   No specific software or tool in the system is capable to detect spoofing of IP or MAC addresses, which makes it susceptible to Masquerading 408 attack.
   However, the system has an advanced logging capability for detecting evasion attempts, i.e., the system can detect the event when the adversary switches from “user” to “root” account to run a (malicious) script.
Based on the assessment of system information the probability for Process injection 406 might be higher than Masquerading 408 because:
   Some of those applications susceptible to Process injection 406 are sharing the same memory space with the Operating System (OS) and could therefore collect and dump the OS credentials at the next step (OS credential dumping 418).
   Although Masquerading technique 408, e.g., IP address spoofing, could succeed, the existing system's firewall policy will block the IP address to avoid further breaches, i.e., the adversary will thus not be able to move forward.
   Attacking the Kerberos system (Kerberoasting 416) is also hard since the adversary must compromise the Kerberos remote system first which already has the latest security patch and is therefore well protected.
Hence, based on the overall assessment the predicted most likely attack path will be Powershell execution→Create account→Process injection→OS credential dumping→Inhibit system recovery.

The method proposed by embodiments of the present invention aims to enrich the existing attack path predictions (e.g., probabilities) with information and insights about the affected IT asset and user (e.g., laptop, server, etc.). Such information may be collected as sets of attributes or properties from the affected IT assets each time they are being targeted by an adversary using a specific attack technique. Hence, in general there two types of set of attributes:
1. Common attributes: attributes or properties that are common to every attack technique or procedure, e.g., type of operating system.
2. Technique-specific attributes: attributes or properties that are specific to each attack technique or procedure, e.g., existence of certain application or service such as Remote Desktop service or Kerberos.

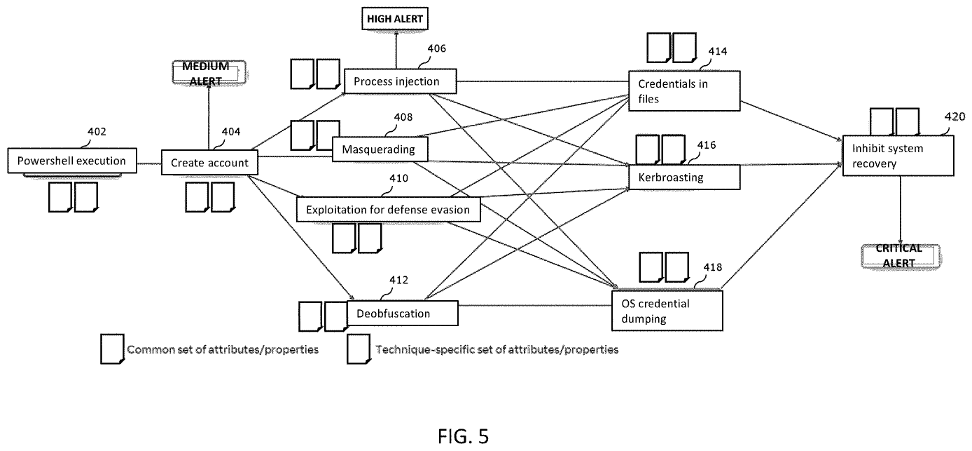

Both sets of attributes may be determined manually for each attack technique (i.e., attributes are determined for each node of the attack graph) based on existing IT and security knowledge, as shown in FIG. 5. The variety of assets and users will make the attack graph model more dynamic and accurate than assuming the same conditions apply across a whole IT environment, since the prediction for the potential/likely attack paths may vary for different IT assets and users.

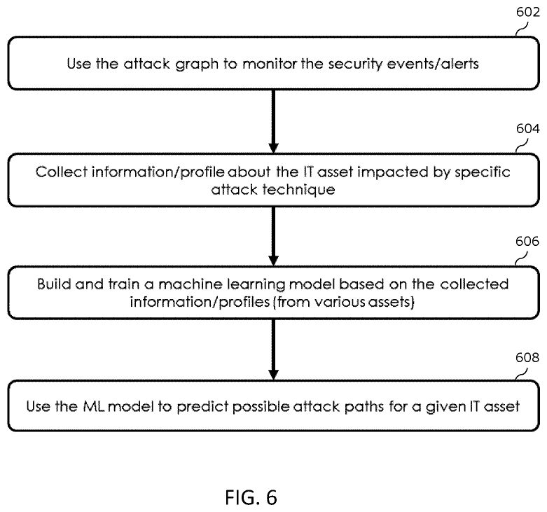

Embodiments of the present invention make use of machine learning techniques to provide attack path prediction based on IT asset (system/network) and/or user specifics. The steps for implementing the method may be summarised as follows (FIG. 6):
1. Once an attack graph 140 has been created using historical attack data 103 (either manually or derived from attack path blueprint 102) it will be used by the cyber-defence system to continuously monitor and correlate the security events (attacks or attempted attacks) that may belong to a kill chain—step 602.
   This is done by correlating the security events with one or more of the attack techniques in the attack graph. The attack graph is created such that each attack technique is located at a node of the attack graph. For example, when an attack is detected, the attack may be correlated to one of the plurality of attack paths contained within the attack graph. For example, an attack may be detected which follows the route: Powershell execution 402→Create account 404→Process injection 406→Credentials in files 414→Inhibit system recovery 420. Thus, the attack would be correlated with those nodes in the attack graph. 2. Each time an attack (or attempted attack) has been detected on an enterprise IT asset (i.e., computer system/network which may belong to a specific user), specific information or profiles in relation with the detected attack technique are gathered—step 604.
   This is done by interrogating the computer system/network to determine one or more attributes relating to each of the nodes which the attack was correlated with.
3. A machine learning model is built, optionally for each potential attack path, and trained using a dataset comprising information and profiles that have been collected previously from various IT assets over specific period of time. This dataset could include the one or more attributes 142, the historical attack data 103 and/or the data relating to the monitored attacks or attempted attacks—step 606.
   The more training data available, the more accurate the model. Thus, it may be advantageous to train the machine learning model based on both the historical attack data 103 and the data relating to the monitored attacks/attempted attacks. This may be thought of as updating the historical attack data 103 to include the data relating to the attacks or attempted attacks detected during the above monitoring steps, prior to training the machine learning model.
4. The trained machine learning model can then be used to predict the attack paths for a given IT asset based on its system interrogation result (i.e., collected information and profile at that given time)—step 608.
   Once the machine learning model outputs the most likely attack path for that computer system/network, mitigation action may then be taken based on this result. This mitigation action may, for example, be implementing security patches, enabling firewalls, etc. The mitigation action may be based on the one or more attributes identified. For example, the method may identify that the most likely attack path to be used uses the Process injection technique 406. The method may have found that by interrogating the system, the reason why the process injection technique is attractive to attackers is because there are security kernel modules missing from the system. The mitigation action to be taken, based on the most likely attack path, would therefore be to deploy those security kernel modules, thereby closing that hole in the security of the system/network.

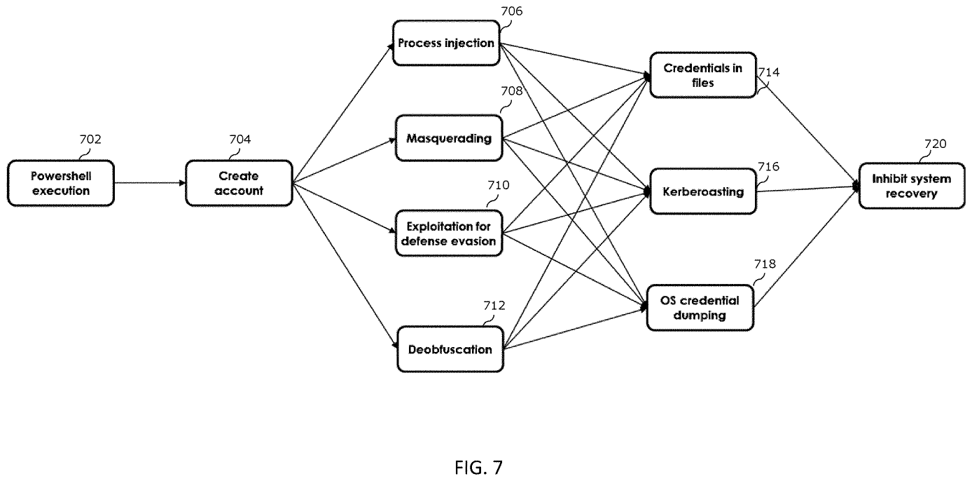

The following paragraphs describe a possible implementation of the machine learning technique to determine the probabilities of attack paths based on a given attack graph model. It is assumed that such attack graph model is created manually or automatically based on observations of historical security events (historical attack data 103). FIG. 7 shows an example attack graph model for which a machine learning model needs to be built and trained for in order to be used for predicting the attack paths.

Embodiments of the present invention specify the following five steps to achieve this:

Step 1: Segment the Attack Graph into Several Sub Attack Graphs

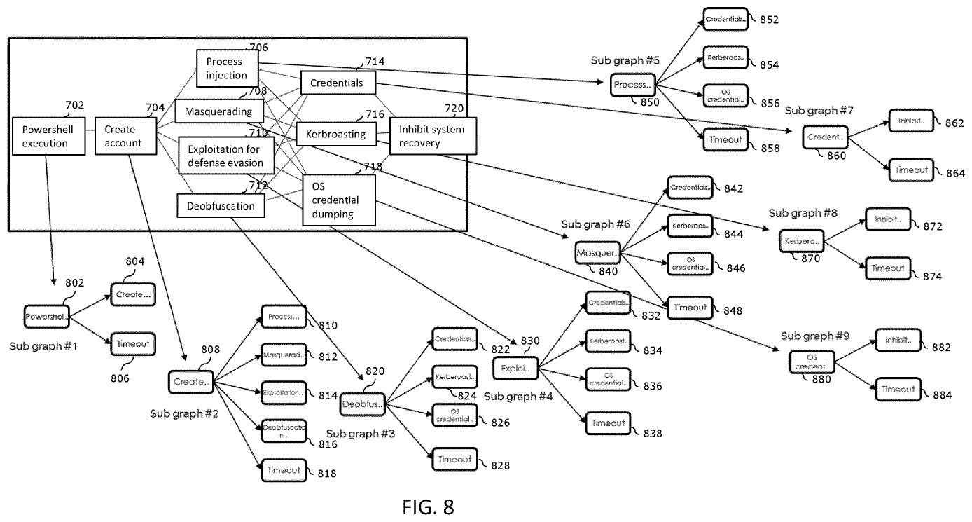

First the complete attack graph needs to be dissected or segmented into several sub attack graphs (also referred to as “subgraphs”). The complete attack graph comprises: powershell execution 702→create account 704→process injection 706 or masquerading 708 or exploitation for defense evasion 710 or deobfuscation 712→credentials in files 714 or kerberoasting 716 or OS credential dumping 718→inhibit system recovery. There are a plurality of attack paths which go between the nodes 702-720, thereby giving every possible attack path through the attack graph from powershell execution 702 to inhibit system recovery 720. Each sub attack graph represents the relationship between two or more succeeding events; each comprises a single starting graph node (i.e., starting event) that is connected to one or more end graph nodes (i.e., end events). As shown in FIG. 8 the complete attack graph will be segmented into a total of nine sub attack graphs.

For each sub attack graph a new node or event called “Timeout” 806, 818, 828, 838, 848, 858, 864, 874, 884 is added as possible succeeding event. This represents the situation where no further security events (in relation with specific attack technique) have been observed following the starting event after a specific period of time, i.e., timeout.

The first sub attack graph is powershell execution 802→create account 804 or timeout 806. The second sub attack graph is create account 808→process injection 810 or masquerading 812 or exploitation for defense evasion 814 or deobsfuscation 816 or timeout 818. The third sub attack graph is deobsfuscation 820→credentials in files 822 or kerberoasting 824 or OS credential dumping 826 or timeout 828. The fourth sub attack graph is exploitation for defense evasion 830→credentials in files 832 or kerberoasting 834 or OS credential dumping 836 or timeout 838. The fifth sub attack graph is process injection 850→credentials in files 852 or kerberoasting 854 or OS credential dumping 856 or timeout 858. The sixth sub attack graph is masquerading 840→credentials in files 842 or kerberoasting 844 or OS credential dumping 846 or timeout 848. The seventh sub attack graph is credentials in files 860→inhibit system recovery 862 or timeout 864. The eighth sub attack graph is kerberoasting 870→inhibit system recovery 872 or timeout 874. The ninth sub attack graph is OS credential dumping 880→inhibit system recovery 882 or timeout 884.

The intention for segmenting the attack graph is to build a prediction model for each part of the (complete) kill chain or attack path (step 2 below). The combination of all prediction models built from each sub attack graph will later result in the overall prediction of the attack path (step 4 below).

### Step 2: Build a Machine Learning Model for Sub Attack Graph

A probabilistic classifier model should be built for each sub attack graph. A probabilistic classifier is a classifier that can predict, given an observation of an input, a probability distribution over a set of classes, rather than only outputting the most likely class that the observation should belong toⁱⁱ. In this case the set of target/succeeding nodes/events in the sub attack graph (including the timeout) represents the set of classes to be predicted by the ML model. Error! Reference source not found.9 shows the ML model for a generalised sub attack graph where each node represents specific attack technique. ⁱⁱ Probabilistic classification—Wikipedia

The problem that needs to be solved by the ML model is: “Given ‘Attack Technique A’ 902 what is the probability that the next step taken by the adversary will be using ‘Attack Technique B 904, C 906, D 908’ or none of them (i.e., timeout 910)?”. The ML model should provide the probabilities for each of those possible outcomes (i.e., attack techniques B, C, D, or timeout).

Based on the example shown in Error! Reference source not found.9 the input features for the classifier model are composed of features sets X_{A}, X_{B}, X_{C}, and X_{D}. Each feature set is a collection of the system information and profiles (i.e., the one or more attributes) gathered from the target/victim system during the observation of security events (attacks or attempted attacks). As mentioned earlier such feature sets comprise common and technique-specific sets of attributes (cf. Error! Reference source not found.5). The collection of those attributes/features along with the observed outcomes will form the training dataset for the ML model, i.e., supervised machine learningⁱⁱⁱ. ⁱⁱⁱ Supervised learnings—Wikipedia

### Step 3: Train the Machine Learning Classifier Model

Using the example model shown in Error! Reference source not found.9, the training dataset can be generated using the following approach:
1. Assume that the cyber-defence system has observed that an adversary has used the “Attack Technique C 906” after they previously used “Attack Technique A 902” on a given victim system.
2. The cyber-defence system then interrogates that victim system to collect the common and technique-specific attributes related to attack techniques A, B, C and D.
3. Those collected attributes will be used to derive the features sets X_{A}, X_{B}, X_{C} and X_{D}.
4. The feature sets X_{A}, X_{B}, X_{C} and X_{D} are combined with the observed outcome (i.e., ‘Attack Technique C’ 906) to form a datapoint in the training dataset for the given ML model/sub attack graph. In this way, the ML model is trained based on the one or more attributes and the historical attack data and/or the data relating to the monitored security events. The observed outcome is derived from the historical attack data and/or the data relating to the monitored security events.
5. Additional datapoints that are based on the observation of various outcomes involving different IT assets and users are then generated (Step 1 to 4) to complete/improve the training dataset.

An example machine learning algorithm that can be used to build the probability classifier is the Naïve Bayes Classifier^{iv}. It is a supervised learning algorithm to find the class of observation (datapoint) given the values of features. Once the training phase has been completed the trained ML model can be used to predict the outcome as a (conditional) probability of the use of attack technique B, C, D or timeout, i.e., p(Yᵢ|X), given the attack technique A being previously observed as well as a set of feature values X={X_{A}, X_{B}, X_{C}, X_{D}} that is based on the interrogation of the affected/victim system at the time of prediction (Error! Reference source not found.10). For the rest of the document the probability p(Yᵢ|X) is referred to as the (conditional) probability of sub-paths. ^{iv} https://towardsdatascience.com/naive-bayes-classifier-explained-50f9723571ed

### Step 4: Calculate the Attack Path Probability

In Step 3 the probability for the outcomes in each segment of the attack graph (i.e., each sub attack graph (“subgraph”)) can be determined. The sequence of such determined sub-paths from the subgraphs will form the complete attack path. Hence the probability of a complete attack path can be calculated as the product of the probabilities of each relevant sub-paths. In the example shown in Error! Reference source not found.1, the probability of full attack path Path 1 is a product of the (conditional) probabilities of two sub-paths using the combined features sets X₁ and X₂. In the first sub attack graph the sub-path is between attack technique A and attack technique B. The second sub-path is between attack technique B and attack technique E. Hence the probability for Path 1 is:

$${P}_{path 1} = p ( {Y}_{B} \vert {X}_{1} ) \cdot p ( {Y}_{E} \vert {X}_{2} )$$

### Step 5: Predict the Most Likely Attack Path

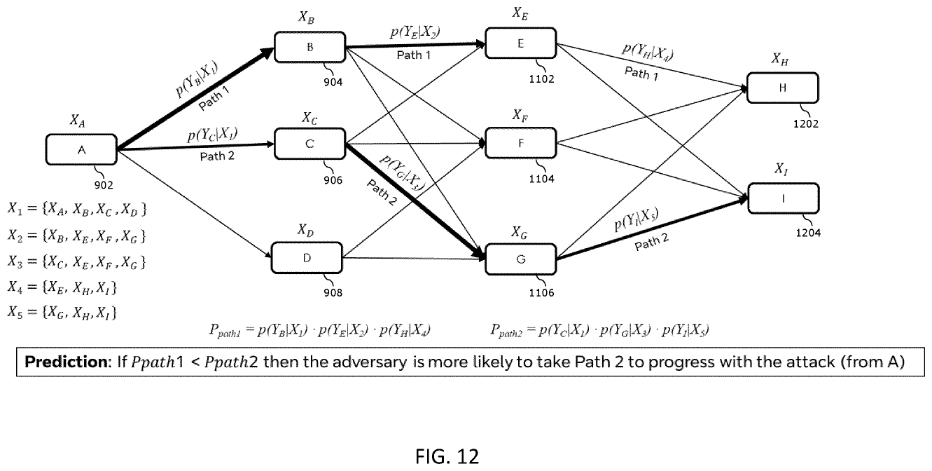

In this final Step 5 the probabilities of each possible full attack paths will be compared to predict the attack path that an adversary may likely to take to progress the kill chain. Error! Reference source not found. shows an example where two full attack paths, i.e., Path 1 and Path 2, are being compared to each other. In FIG. 12, more likely attack paths are thicker than less likely attack paths.

The probability of each attack path is composed of the probabilities of their relevant sub-paths. Assumed that Pₚₐₜₕ₁<Pₚₐₜₕ₂ then the cyber-defence system will give the prediction that the adversary will likely take Path 2 to progress with their attack on the given victim system. It should be noted that interrogation of different target/victim systems may lead to different outcomes/predictions.

### Mitigation Action

The machine learning system is trained to output the most likely attack path for a given computer system or network (which may be user profile specific). Based on this output, mitigation action can be taken to improve the security of the system or network by preventing or reducing cyberattacks. Embodiments of the present invention may, based on the output of the machine learning system, automatically suggest mitigation action to a user (such as a cybersecurity team) such that the mitigation action may be taken manually, or automatically perform this mitigation action without further input.

For example, the ML model may identify that the most likely attack path to be used uses the process injection technique 406. By interrogating the system, the method may suggest that the reason why the process injection technique is attractive to attackers is because there are security kernel modules missing from the system (a weakness). The mitigation action to be taken, based on the most likely attack path, would therefore be to deploy those security kernel modules, thereby closing that hole in the security of the system/network. As such, embodiments of the invention may output a suggestion to deploy those security kernel modules. The suggestion may then be taken by someone in the cybersecurity team and implemented. Alternatively, embodiments of the invention may automatically deploy the security kernel modules.

As such, embodiments of the invention may take or suggest mitigation action, the mitigation action comprising minimising or fixing weaknesses in the computer network or system in order to deter attackers from using the identified most likely attack path. The weaknesses are identified in the one or more attributes during the interrogation of the system/network. As a consequence of the mitigation action taken, the identified most likely attack path will ideally no longer be the most likely attack path. The ML model can then be re-trained with the latest data, thus re-interrogating the system/network to update the one or more attributes to reflect the mitigation action taken. There will therefore be a new most likely attack path and the mitigation process can be repeated to fix weaknesses making this attack path most attractive. This can repeat until the computer system/network reaches a desired threshold of security.

Various modifications whether by way of addition, deletion, or substitution of features may be made to above described embodiment to provide further embodiments, any and all of which are intended to be encompassed by the appended claims.

1. A computer-implemented method for predicting attack paths in a computer system or network, the method comprising:
obtaining historical attack data relating to the computer system or network, the historical attack data comprising data relating to previous attacks or previous attempted attacks on the computer system or network;
creating an attack graph based on the historical attack data, the attack graph comprising: (i) a plurality of nodes relating to a plurality of attack techniques, and (ii) a plurality of possible attack paths;
monitoring the computer system or network for attacks or attempted attacks and correlating those attacks or attempted attacks with one or more of the plurality of nodes;
interrogating the computer system or network to determine one or more attributes relating to each of the one or more of the plurality of nodes;
training a machine learning model to predict the most likely attack path of the plurality of possible attack paths based on: (i) the one or more attributes; and (ii) the historical attack data and/or data relating to the monitored attacks or attempted attacks;
using the trained machine learning model to output a prediction of the most likely attack path for the computer system or network such that mitigation action can be taken to prevent or reduce cyberattacks in the computer system or network in dependence on the prediction of the most likely attack path.

2. The computer-implemented method of claim 1, wherein the method further comprises outputting a suggestion of mitigation action to prevent or reduce cyberattacks in the computer system or network in dependence on the prediction of the most likely attack path, the suggestion being outputted to a user.

3. The computer-implemented method of claim 1, wherein the method further comprises taking mitigation action to prevent or reduce cyberattacks in the computer system or network in dependence on the prediction of the most likely attack path.

4. The computer-implemented method of claim 2, wherein the mitigation action comprises minimising one or more weaknesses in the computer system or network, the one or more weaknesses being identified in the one or more attributes.

5. The computer-implemented method of claim 3, wherein the method further comprises repeating the method of claim 1 after mitigation action has been taken to output an updated prediction of the most likely attack path.

6. The computer-implemented method of claim 5, wherein the method further comprises outputting an updated suggestion of mitigation action in dependence on the updated prediction, the updated suggestion being outputted to a user.

7. The computer-implemented method of claim 1, wherein the machine learning model is dynamically updated when new historical attack data becomes available.

8. The computer-implemented method of claim 7, wherein the dynamic updating comprises repeating with the new historical attack data.

9. The computer-implemented method of claim 1, wherein the interrogating step is performed upon detection of an attack or an attempted attack during the monitoring of the computer system or network.

10. The computer-implemented method of claim 1, wherein the method further comprises obtaining an attack path blueprint of the computer system or network, and wherein the creating of the attack graph uses the historical attack data and the attack path blueprint.

11. The computer-implemented method of claim 1, wherein the method is for predicting attack paths for a specific user profile in a computer system or network, such that the computer system or network is a specific user profile of the computer system or network, such that the most likely attack path is predicted for the specific user profile.

12. The computer-implemented method of claim 1, wherein the machine learning model predicts the most likely attack path of the plurality of attack paths by:
(a) for each of the plurality of possible attack paths, determining a probability of an attacker using that attack path based on (i) the one or more attributes; and (ii) the historical attack data; and
(b) selecting the attack path with the highest probability as the most likely attack path.

13. The computer-implemented method of claim 1, wherein the machine learning model predicts the most likely attack path of the plurality of possible attack paths by:
(a) dividing the attack graph into a plurality of subgraphs, each subgraph comprising a subset of the plurality of nodes and a plurality of subgraph paths, wherein each subgraph path is part of at least one of the plurality of possible attack paths, and each subgraph path connects a first node to a second node;
(b) for each subgraph path, determining a probability of an attacker taking that subgraph path based on (i) the one or more attributes relating to the second node; and (ii) the historical attack data;
(c) for each of the plurality of possible attack paths, determining a probability of an attacker using that attack path by:
i. determining which subgraph paths combine to form the attack path; and
ii. combining the probabilities associated with the determined subgraph paths together; and
(d) selecting the attack path with the highest probability as the most likely attack path.

14. The computer-implemented method of claim 13, wherein for each subgraph path, determining a probability of an attacker taking that subgraph path is additionally based on the one or more attributes relating to the first node.

15. A system comprising:
a processor; and
a memory including computer program code;
the memory and the computer code configured to, with the processor, cause the system to perform the method of claim 1.
